(19) United States
(12) Patent Application Publication
(10) Pub. No.: US 2026/0045065 A1
(43) Pub. Date: Feb. 12, 2026

(54) IMAGE DATA PROCESSING DEVICE AND IMAGE DATA PROCESSING METHOD

(71) Applicant: LITE-ON TECHNOLOGY CORPORATION, TAIPEI CITY (TW)

(72) Inventors: Hsuan Ta LIN, TAIPEI CITY (TW); TseChun WANG, TAIPEI CITY (TW)

(21) Appl. No.: 19/285,088

(22) Filed: Jul. 30, 2025

Related U.S. Application Data
(60) Provisional application No. 63/679,663, filed on Aug. 6, 2024.

(30) Foreign Application Priority Data
Jun. 16, 2025 (CN) 202510799271.6

(51) Int. Cl. G06V 10/764; G06V 10/70; G06V 20/70

(52) U.S. Cl. CPC G06V 10/764; G06V 10/768; G06V 20/70; G06V 2201/10

(57) ABSTRACT

An image data processing device includes a memory and a processor. The processor is configured to execute following steps based on a plurality of instructions of the memory: annotating a plurality of features in an image with corresponding a plurality of annotation data by using an annotation algorithm; and generating a meta-data by using a translation function based on a keyword and the plurality of annotation data; wherein the meta-data is related to the keyword.

### CROSS REFERENCE TO RELATED APPLICATIONS

This Application claims priority of U.S. Provisional Application No. 63/679,663, filed on Aug. 6, 2024, the entirety of which is incorporated by reference herein.

This Application claims priority of China Patent Application No. 202510799271.6, filed on Jun. 16, 2025, the entirety of which is incorporated by reference herein.

### BACKGROUND OF THE INVENTION

### Field of the Invention

The present invention relates to a data processing device and data processing method, and, in particular, to an image data processing device and image data processing method.

### Description of the Related Art

Currently, the training process in computer vision involves input, training, and output stages. In the input stage, selecting appropriate data to be fed into the model is one of the key aspects. However, images used for training models typically lack accurate subject data, which may result in incorrect images being input into the model, thereby causing training errors. Alternatively, the need to manually select suitable images in advance may lead to prolonged training time.

Furthermore, images may be preprocessed to include correct or relevant image data, a process also referred to as image data cleaning. Nevertheless, such a process may also be time-consuming or inefficient.

Accordingly, a data processing device capable of improving the efficiency of image data cleaning and selection is an urgent topic for research and development.

### BRIEF SUMMARY OF THE INVENTION

The Summary of the Invention aims to provide a simplified summary of the present disclosure, so that readers can have a basic understanding of the present disclosure. This Summary of the Invention is not a complete overview of the present disclosure, and its intention is not to point out important/key elements of the embodiments of the present application or to define the scope of the present application.

An embodiment of the present invention provides an image data processing device. The image data processing device includes a memory and a processor. The processor is configured to execute following steps based on a plurality of instructions from the memory: annotating a plurality of features in an image with a plurality of annotation data by using an annotation algorithm; and generating a meta-data by using a translation function based on a keyword and the plurality of annotation data. The meta-data is related to the keyword. The plurality of annotation data corresponds to the image.

In one embodiment, the processor further executes the following steps: creating a data inventory, wherein the data inventory comprises an image name data corresponding to the image and the plurality of annotation data corresponding to the image; and outputting the meta-data corresponding to the image based on the plurality of annotation of the data inventory; wherein the meta-data is related to the plurality of annotation data corresponding to the image.

In one embodiment, the processor further executes the following steps: obtaining a first image, wherein the image comprises the first image; and outputting a positive example meta-data based on a first annotation data of the first image and the keyword; wherein the first annotation data comprises the keyword; wherein the meta-data comprises the positive example meta-data.

In one embodiment, the processor further executes the following steps: obtaining a second image; outputting a negative example meta-data based on a second annotation data of the second image and the keyword; wherein the second annotation data does not comprise the keyword.

In one embodiment, the processor further executes the following steps: determining whether the plurality of annotation data corresponding to the image comprises the keyword; and when it is determined that the plurality of annotation data corresponding to the image comprises the keyword, outputting a positive example meta-data; wherein the meta-data comprises the positive example meta-data.

In one embodiment, the processor further executes the following steps: when it is determined that the plurality of annotation data corresponding to the image does not comprise the keyword, outputting a negative example meta-data; wherein the meta-data comprises the negative example meta-data.

In one embodiment, the processor further executes the following steps: obtaining the plurality of object features of the image by using an image encoder, wherein the annotation algorithm comprises the image encoder; and determining a plurality of association degrees between the plurality of object features and a plurality of label data based on the plurality of object features and the plurality of label data.

In one embodiment, the processor further executes the following steps: generating the plurality of annotation data based on the plurality of object features and the plurality of association degrees by using a decoder; wherein the annotation algorithm comprises the decoder.

In one embodiment, the processor further executes the following steps: generating a compound word meta-data based on the plurality of annotation data of the data inventory by using a translation function; wherein the meta-data comprises the compound word meta-data.

In one embodiment, the processor further executes the following steps: performing an integrated determination based on the plurality of annotation data by using the translation function to generate a compound vocabulary meta-data; wherein the meta-data comprises the compound vocabulary meta-data.

Another embodiment of the present invention provides an image data processing method. The image data processing method includes the following steps: annotating a plurality of features in an image with corresponding a plurality of annotation data by using an annotation algorithm; and generating a meta-data by using a translation function based on a keyword and the plurality of annotation data. The meta-data is related to the keyword. The plurality of annotation data corresponds to the image.

In one embodiment, the image data processing method further includes the following steps: creating a data inventory, wherein the data inventory comprises an image name data corresponding to the image and the plurality of annotation data corresponding to the image; and outputting the meta-data corresponding to the image based on the plurality of annotation of the data inventory; wherein the meta-data is related to the plurality of annotation data corresponding to the image.

In one embodiment, the image data processing method further includes the following steps: obtaining a first image, wherein the image comprises the first image; and outputting a positive example meta-data based on a first annotation data of the first image and the keyword; wherein the first annotation data comprises the keyword; wherein the meta-data comprises the positive example meta-data.

In one embodiment, the image data processing method further includes the following steps: obtaining a second image; outputting a negative example meta-data based on a second annotation data of the second image and the keyword; wherein the second annotation data does not comprise the keyword.

In one embodiment, the image data processing method further includes the following steps: determining whether the plurality of annotation data corresponding to the image comprises the keyword; and when it is determined that the plurality of annotation data corresponding to the image comprises the keyword, outputting a positive example meta-data; wherein the meta-data comprises the positive example meta-data.

In one embodiment, the image data processing method further includes the following steps: when it is determined that the plurality of annotation data corresponding to the image does not comprise the keyword, outputting a negative example meta-data; wherein the meta-data comprises the negative example meta-data.

In one embodiment, the image data processing method further includes the following steps: obtaining the plurality of object features of the image by using an image encoder, wherein the annotation algorithm comprises the image encoder; and determining a plurality of association degrees between the plurality of object features and a plurality of label data based on the plurality of object features and the plurality of label data.

In one embodiment, the image data processing method further includes the following steps: generating the plurality of annotation data based on the plurality of object features and the plurality of association degrees by using a decoder; wherein the annotation algorithm comprises the decoder.

In one embodiment, the image data processing method further includes the following steps: generating a compound word meta-data based on the plurality of annotation data of the data inventory by using a translation function; wherein the meta-data comprises the compound word meta-data.

In one embodiment, the image data processing method further includes the following steps: performing an integrated determination based on the plurality of annotation data by using the translation function to generate a compound vocabulary meta-data; wherein the meta-data comprises the compound vocabulary meta-data.

Therefore, according to the technical content of the present disclosure, the image data processing device and image data processing method shown in the embodiment of the present disclosure can achieve the effect of image data cleaning by utilizing an annotation algorithm and keyword S.

Other features and aspects of the present disclosure will become apparent from the following detailed description of exemplary embodiments with reference to the accompanying drawings.

### BRIEF DESCRIPTION OF THE DRAWINGS

The views of the embodiments of the present disclosure can be better understood through the following detailed description combined with the accompanying drawings. It is worth noting that, according to standard industrial practice, some features may not be drawn to scale. In fact, to facilitate clear description, the dimensions of different features may be increased or decreased, wherein:

FIG. 1 is a block diagram of an image data processing device according to one embodiment of the present disclosure.

FIG. 2 is a schematic diagram of a plurality of operational steps of an image data processing device according to one embodiment of the present disclosure.

FIG. 3A is a schematic diagram of an image of a plurality of operational steps of an image data processing device according to one embodiment of the present disclosure.

FIG. 3B is a schematic diagram of an image of a plurality of operational steps of an image data processing device according to one embodiment of the present disclosure.

FIG. 4 is a schematic diagram of a plurality of operational steps of an image data processing device according to one embodiment of the present disclosure.

FIG. 5 is a schematic diagram of a plurality of operational steps of an image data processing device according to one embodiment of the present disclosure.

FIG. 6 is a schematic diagram of a plurality of operational steps of an image data processing device according to one embodiment of the present disclosure.

FIG. 7 is a schematic diagram of a plurality of operational steps of an image data processing device according to one embodiment of the present disclosure.

FIG. 8 is a schematic diagram of a plurality of operational steps of an image data processing device according to one embodiment of the present disclosure.

FIG. 9 is a flowchart of an image data processing method according to one embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

To make the description of the present disclosure more detailed and complete, illustrative descriptions of the implementation aspects and exemplary embodiments of the present application are provided below; however, this is not the only form for implementing or using the exemplary embodiments of the present application. The embodiments cover features of multiple exemplary embodiments and method steps and their sequences used to construct and operate these exemplary embodiments. However, the same or equivalent functions and step sequences can also be achieved using other exemplary embodiments.

Unless otherwise defined in this specification, the meaning of scientific and technical terms used herein is the same as understood and customarily used by a person having ordinary skill in the art to which the present application pertains. Furthermore, without conflicting with the context, singular nouns used in this specification cover the plural form of the noun; and plural nouns used also cover the singular form of the noun.

In addition, regarding “coupled” or “connected” as used herein, it may refer to two or more elements being in direct physical or electrical contact with each other, or being in indirect physical or electrical contact with each other, or it may refer to two or more elements mutually operating or acting.

Some embodiments of the present disclosure can be understood in conjunction with the drawings. The drawings of the embodiments of the present disclosure are also considered a part of the description of the embodiments of the present disclosure. It should be understood that the drawings of the embodiments of the present disclosure are not drawn to the actual proportions of devices and elements. In the drawings, the shape and thickness of the embodiments may be exaggerated to clearly illustrate the features of the embodiments of the present disclosure. Furthermore, structures and devices in the drawings are schematically illustrated to clearly illustrate the features of the embodiments of the present disclosure.

Herein, the term “device” generally refers to an object comprising one or more transistors and/or one or more active and/or passive components connected in a certain manner to process signals.

Herein, the terms “about,” “approximately,” and “substantially” generally indicate within 20% of a given value or range, preferably within 10%, and more preferably within 5%, or within 3%, or within 2%, or within 1%, or within 0.5%. Here, a given quantity is an approximate quantity, meaning that even without specific mention of “about,” “approximately,” or “substantially,” the meaning of “about,” “approximately,” or “substantially” can still be implied.

Certain terms are used in the specification and the claims to refer to specific elements. However, a person having ordinary skill in the art should understand that the same elements may be referred to by different names. The specification and the claims do not use differences in names as a way to distinguish elements, but rather use differences in function of the elements as the basis for distinction. The term “comprising” as mentioned in the specification and the claims is an open-ended term, and thus should be interpreted as “comprising but not limited to”.

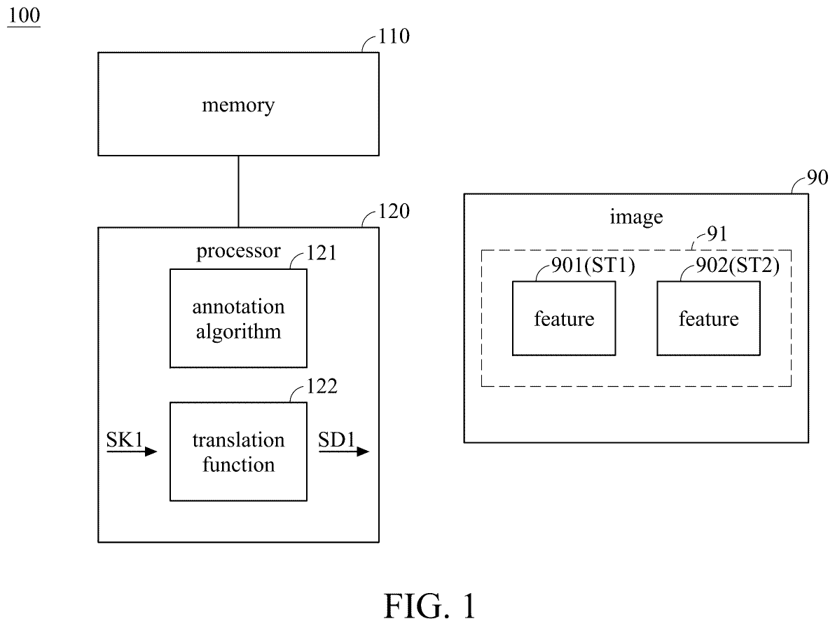

FIG. 1 is a block diagram of an image data processing device according to one embodiment of the present disclosure. As shown in FIG. 1, in one embodiment, the image data processing device 100 includes a memory 110 and a processor 120. In a coupling relationship, the memory 110 is coupled to the processor 120. The memory 110 may store a plurality of instructions, the processor 120 may perform an annotation algorithm 121 and/or a translation function 122 on the image 90.

For example, image 90 may have a plurality of features 91, the processor 120 may perform the annotation algorithm 121 on each of the plurality of features 91 of the image 90, the annotation algorithm 121 may be an annotator or an annotation unit, and the translation function 122 may be a translation unit or a translator (also referred to as a converter, but the present disclosure is not limited thereto.

In some embodiments, the annotation algorithm 121 and/or the translation function 122 may be stored in the memory 110, but the present disclosure is not limited thereto. In some embodiments, the annotation algorithm 121 and/or the translation function 122 may be stored in a storage device external to the image data processing device 100, but the present disclosure is not limited thereto.

In some embodiments, the processor 120 may be a System-on-Chip (SoC), a Microprocessor Unit (MPU), a Central Processing Unit (CPU), a Graphics Processing Unit (GPU), a Microcontroller Unit (MCU), a microprocessor, a digital signal processor (DSP), a Field Programmable Gate Array (FPGA), an Application Specific Integrated Circuit (ASIC), or a server, among others, but the present disclosure is not limited thereto.

In some embodiments, the memory 110 may include a random-access memory (RAM), a read-only memory (ROM), a cache memory, a flash memory, memory card, a hard disk (e.g., a cloud disk, a network disk, or an external hard disk), an optical disk, a USB flash drive, or a database, among others, but the present disclosure is not limited thereto. In some embodiments, the plurality of instructions stored in the memory 110 may be any type of program code, algorithm, software, or firmware, but the present disclosure is not limited thereto.

In some embodiments, the image data processing device 100 may include functionalities of tagging and translating into the meta-data, but the present disclosure is not limited thereto.

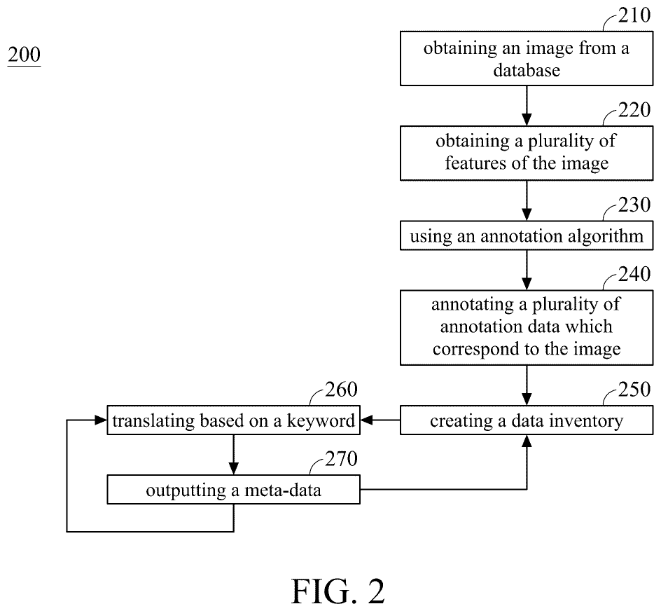

FIG. 2 is a schematic diagram of a plurality of operational steps of an image data processing device according to one embodiment of the present disclosure. As shown in FIG. 2, in one embodiment, the image data processing method 200 includes a plurality of steps 210 to 270. For example, the plurality of operational steps of the image data processing device 100 shown in FIG. 1 correspond to the image data processing method 200, but the present disclosure is not limited thereto.

For a detailed description of the plurality of steps 210 to 270 shown in FIG. 2, reference is also made to FIG. 1 and FIG. 2. The following provides a detailed explanation of the plurality of steps 210 to 270.

In the step 210, obtaining an image from a database.

In one embodiment, the processor 120 may obtain the image 90 from the database.

For example, the database may correspond to the memory 110 shown in FIG. 1. The database may be internal or external to the image data processing device 100. The image 90 may include landscape images, portrait images, driving record images, and the like, but the present disclosure is not limited thereto.

In some embodiments, the processor 120 obtains a plurality of images 90 from a road scene database (such as the AMOS database), wherein the plurality of images 90 may include a plurality of positive example images and a plurality of negative example images.

For example, a number of the plurality of positive example images may be approximately equal to a number of the plurality of negative example images, such as about 200, but the present disclosure is not limited thereto.

In the step 220, obtaining a plurality of features of the image.

In one embodiment, the plurality of features 91 of the image 90 may be obtained by the processor 120.

For example, the plurality of features 91 may include features 901 and 902. The image 90 may be a road scene image, and features 901 and 902 may correspond to a plurality of objects within the image 90, such as street lamps, vehicles, buildings, and the like, but the present disclosure is not limited thereto.

In the step 230, using an annotation algorithm.

In one embodiment, the processor 120 may use the annotation algorithm 121.

For example, the annotation algorithm 121 may refer to a captioning generative artificial intelligence (AI), such as an image-to-tag (image-2-tag) algorithm. The annotation algorithm 121 may also include a Recognize Anything Module (RAM), a first algorithm (such as Tag2Text), a second algorithm (such as ML-Decoder), a third algorithm (such as BLIP), or a fourth algorithm (such as Google Tapping API), among others, but the present disclosure is not limited thereto.

In the step 240, annotating a plurality of annotation data which correspond to the image.

In one embodiment, the processor 120 may annotate the plurality of annotation data ST1 and ST2 which correspond to the image.

For example, the plurality of annotation data ST1 and ST2 may be textual descriptions that correspond to the appearance or functionality of the plurality of features 901 and 902, but the present disclosure is not limited thereto.

In some embodiments, by combining the step 230 and the step 240. In some embodiments, the processor 120 may annotate the plurality of features 901 and 902 in the image 90 with corresponding annotation data ST1 and ST2 by using the annotation algorithm 121.

For example, the feature 901 may represent the contour of a car, and the annotation data ST1 may be “car.” The feature 902 may represent the contour of a street light or the contour of the street light along with its illumination, and the annotation data ST2 may be “street light”, but the present disclosure is not limited thereto.

In the step 250, creating a data inventory.

In one embodiment, the processor 120 may create a data inventory. In addition, the data inventory includes an image name data corresponding to the image 90, and a plurality of annotation data ST1 and ST2 corresponding to the image 90.

For example, the data inventory may be a table or a table file, and may include the name of the image, the plurality of features 901 and 902 in the image 90, and the plurality of annotation data ST1 and ST2 corresponding to the image 90. The data inventory may be in a comma-separated values (CSV) data inventory, but the present disclosure is not limited thereto.

In some embodiments, the processor 120 may outputs the meta-data SD1 corresponding to the image 90 based on the plurality of annotation data ST1 and ST2 of the data inventory. The meta-data SD1 is related to the plurality of annotation data ST1 and ST2 according to the image 90.

In the step 260, translating based on a keyword.

In one embodiment, the processor 120 may perform a transformation according to the keyword SK1.

For example, the user may set the keyword SK1 to perform the transformation by using the translator, but the present disclosure is not limited thereto.

In the step 270, outputting a meta-data.

In one embodiment, the processor 120 may output the meta-data SD1.

For example, the processor 120 may compare the image 90 and the keyword SK1 to output meta-data SD1.

In some embodiments, after performing the step 270, the output meta-data SD1 may be recorded in the data inventory, and the step 250 may be executed again. In addition, the meta-data SD1 may be related to or correspond to the image 90, but the present disclosure is not limited thereto.

In some embodiments, by combining the step 250 to the step 270. In some embodiments, the processor 120 may generate a meta-data SD1 based on a keyword SK1 and the plurality of annotation data ST1 and ST2 by using a translation function 122. The meta-data SD1 is related to the keyword SK1.

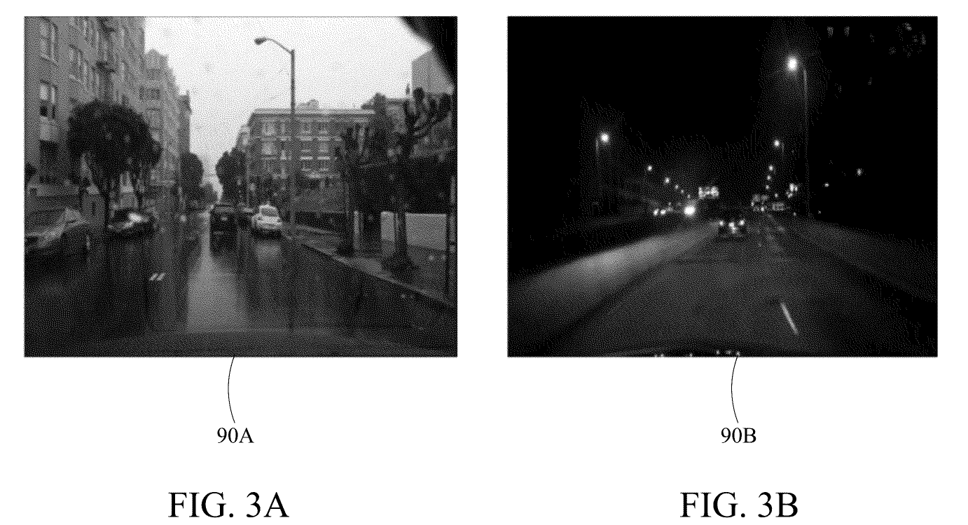

FIG. 3A is a schematic diagram of an image of a plurality of operational steps of an image data processing device according to one embodiment of the present disclosure. As shown in FIG. 3A, in one embodiment, the image 90A may be a daytime street scene. The image 90A includes a plurality of features, and the plurality of features are associated with objects related to the daytime street scene.

For example, the plurality of features in the image 90A may be building outlines, vehicle outlines, urban street views, motion characteristics, rainy weather, rain-related features, road scene outlines, street scene outlines, and wetness-related features, but the present disclosure is not limited thereto.

In some embodiments, the plurality of annotation data corresponding to image 90A may include: “building”, “car”, “city street”, “drive”, “rain”, “rainy”, “road”, “street scene”, and “wet”, but the present disclosure is not limited thereto. In some embodiments, the plurality of annotation data corresponding to image 90A may be obtained by processor 120 of FIG. 1 after performing the step 240 (As shown in FIG. 2), but the present disclosure is not limited thereto.

FIG. 3B is a schematic diagram of an image of a plurality of operational steps of an image data processing device according to one embodiment of the present disclosure. As shown in FIG. 3B, in one embodiment, the image 90B may represent a nighttime street scene. The image 90B includes the plurality of features, and the plurality of features are related to objects associated with the nighttime street scene.

For example, the plurality of features in the image 90B may include vehicle contours, dark features, dashboard contours, driving features, highway contours, headlight contours, lighting features, nighttime features, night scene features, road contours, streetlight contours, and windshield contours, but the present disclosure is not limited thereto.

In some embodiments, the plurality of annotation data corresponding to the image 90B may include “car”, “dark”, “dashboard”, “drive”, “highway”, “headlight”, “light”, “night”, “night view”, “road”, “street light”, and “windshield”, but the present disclosure is not limited thereto. In some embodiments, the plurality of annotation data corresponding to image 90B may be obtained by processor 120 of FIG. 1 after performing the step 240 (As shown in FIG. 2), but the present disclosure is not limited thereto.

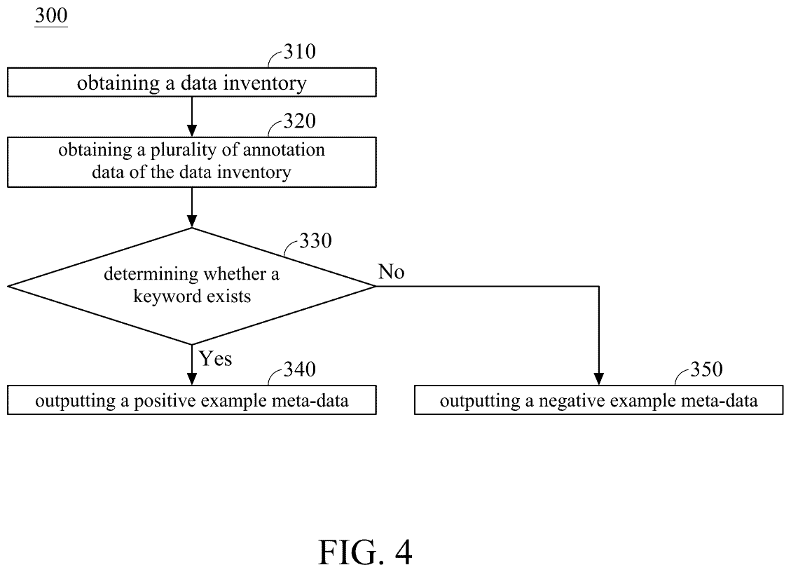

FIG. 4 is a schematic diagram of a plurality of operational steps of an image data processing device according to one embodiment of the present disclosure. As shown in FIG. 4, in one embodiment, the image data processing method 300 includes the plurality of steps 310 to 350. For example, the plurality of operation steps of the image data processing device 100 shown in FIG. 1 may correspond to the image data processing method 300, but the present disclosure is not limited thereto.

For a detailed description of the technical content of the plurality of steps 310 to 350 shown in FIG. 4, reference is also made to FIG. 1 and FIG. 4. A detailed explanation of the plurality of steps 310 to 350 is provided below.

In the step 310, obtaining a data inventory.

In one embodiment, the processor 120 may obtain the data inventory.

In the step 320, obtaining a plurality of annotation data of the data inventory.

In one embodiment, the processor 120 may obtain the plurality of annotation data ST1 and ST2 in the data inventory. In some embodiments, the processor 120 may obtain at least one of a first image and a second image, and the first image includes the image 90.

For example, the first image may be the image 90A shown in FIG. 3A, the second image may be the image 90B shown in FIG. 3B, and the image 90A may be different from the image 90B. The image 90A may include one annotation data (such as daytime), the image 90B may include another annotation data (such as daytime or nighttime), but the present disclosure is not limited thereto.

In some embodiments, the processor 120 may obtain the image 90, and the image 90 includes the first image. Subsequently, the processor 120 may obtain the second image.

In the step 330, determining whether a keyword exists.

In one embodiment, the processor 120 may determine whether the keyword SK1 exists. In some embodiments, the processor 120 may determine whether the plurality of annotation data ST1 and ST2 corresponding to the image 90 includes the keyword SK1.

For example, the keyword SK1 may be “night,” and the image 90 may be either image 90A or image 90B. The plurality of annotation data ST1 and ST2 may indicate either “night” or “day”, but the present disclosure is not limited thereto.

In the step 340, outputting a positive example meta-data.

In one embodiment, the processor 120 may output a positive example meta-data based on a first annotation data of the first image 90B and the keyword SK1, the first annotation data includes the keyword SK1, and the meta-data includes the positive example meta-data.

For example, the first image 90B may be a nighttime street scene, the first annotation data may indicate “night.” The processor 120 may use a translator to convert the first annotation data into the positive example meta-data, such as “night”, but the present disclosure is not limited thereto.

In some embodiments, when it is determined that the plurality of annotation data corresponding to the image (such as the first image 90B) includes the keyword SK1, the processor 120 may output a positive example meta-data

For example, the processor 120 may compare the plurality of annotation data with the keyword SK1, and when at least one of the annotation data is the same as the keyword SK1, the processor 120 may convert at least one of the annotation data into positive example meta-data by using a translator, but the present disclosure is not limited thereto.

In the step 350, outputting a negative example meta-data.

In one embodiment, the processor 120 may output a negative example meta-data based on a second annotation data of the second image 90A and the keyword SK1, and the second annotation data does not include the keyword SK1.

For example, the second image 90A may be a daytime street scene, the second annotation data may be the daytime instead of “night” of keyword SK1, and the processor 120 may convert the second annotation data into the negative example meta-data (such as the daytime) by using the translator. In addition, the second annotation data may not be the keyword SK1, but the present disclosure is not limited thereto.

In one embodiment, when it is determined that the plurality of annotation data corresponding to the image (such as the first image 90B) does not include the keyword SK1, the processor 120 may output a negative example meta-data.

For example, when the processor 120 determines that one of the plurality of annotation data is different from the keyword SK1, the processor 120 may convert at least one of the plurality of annotation data into the negative example meta-data by using the translator, but the present disclosure is not limited thereto. In some embodiments, meta-data that differs from the positive example meta-data may be regarded as negative example meta-data, and the terms “positive example meta-data” and/or “negative example meta-data” are not associated with any affirmative or negative connotations, but merely serve as naming distinctions; however, the present disclosure is not limited thereto.

In some embodiments, the step 310 and/or the step 320 of FIG. 3 may correspond to the step 250 of FIG. 2, the step 330 of FIG. 3 may correspond to the step 260 of FIG. 2, and the step 340 and/or the step 350 of FIG. 3 may correspond to the step 260 of FIG. 2, but the present disclosure is not limited thereto.

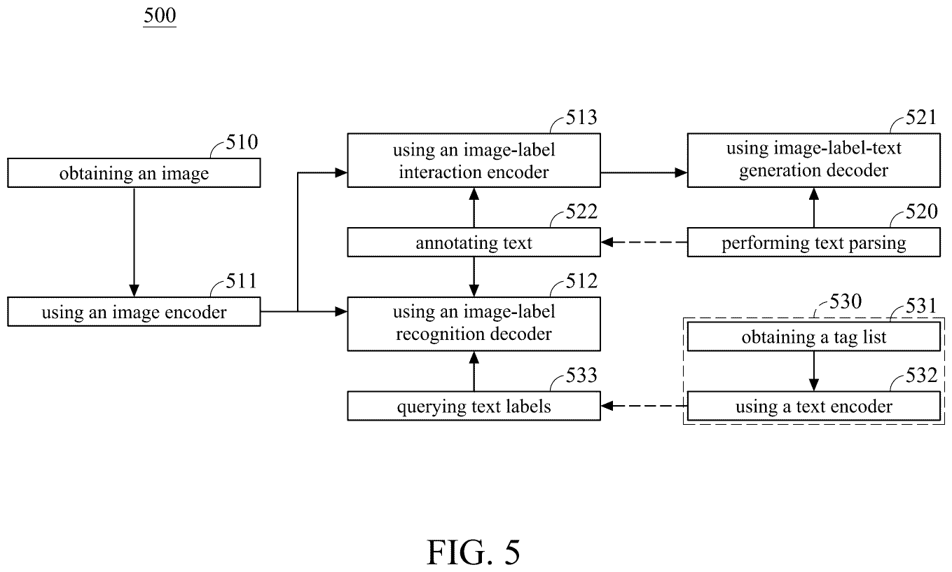

FIG. 5 is a schematic diagram of a plurality of operational steps of an image data processing device according to one embodiment of the present disclosure. As shown in FIG. 5, in one embodiment, the image data processing method 500 includes a plurality of steps 510 to 530, 511 to 513, 521, 522, and 531 to 533. For example, a plurality of operation steps of the image data processing device 100 in FIG. 1 may correspond to the image data processing method 500, but the present disclosure is not limited thereto.

For a detailed description of the technical content of the plurality of steps 510 to 530, 511 to 513, 521, 522, and 531 to 533 in FIG. 5, please refer to FIG. 1 through FIG. 5. The following provides a detailed explanation of the plurality of steps 510 to 530, 511 to 513, 521, 522, and 531 to 533.

In the step 510, obtaining an image.

In one embodiment, the processor 120 may obtain the image 90, 90A, and/or 90B.

In the step 511, using an image encoder.

In one embodiment, the processor 120 may use the image encoder. For example, the image encoder may extract features from the image, but the present disclosure is not limited thereto.

In one embodiment, the processor 120 obtains the plurality of object features from image 90, 90A, and/or 90B by using an image encoder, and the annotation algorithm includes the image encoder.

For example, the annotation algorithm of FIG. 1 may include the image encoder, and the plurality of object features may correspond to the contours or shapes of multiple objects. Furthermore, the annotation algorithm may be implemented as the image encoder, but the present disclosure is not limited thereto.

In some embodiments, the image encoder can perform an image captioning task, and the image captioning task assigns appropriate descriptions or thematic text to the image, but the present disclosure is not limited thereto.

In the step 512, using an image-label recognition decoder.

In one embodiment, the processor 120 may use the image-tag recognition decoder (also referred to as the image-label recognition decoder).

For example, the annotation algorithm of FIG. 1 may include an image-tag recognition decoder, the image-tag recognition decoder may be used for mapping and/or identifying the relationship and/or correspondence between images and tags, but the present disclosure is not limited thereto.

In one embodiment, the processor 120 obtains the correlation degree between the plurality of object features and a plurality of label data based on the plurality of object features and the plurality of label data. The label data originates from a predefined set of labels in the model of the annotation algorithm.

For example, after performing the step 533 and/or the step 522, the processor 120 may obtain a plurality of label data. Then, the processor 120 may use the image-tag recognition decoder to compare the plurality of object features with the plurality of label data to obtain the correlation degree between them, but the present disclosure is not limited thereto. In addition, the calculation of the correlation degree is performed through an artificial intelligence model, wherein a cross-attention mechanism is utilized to improve the matching accuracy between the plurality of object features and label data. During the matching process, the processor 120 generates confidence scores for each label in a label set based on feature similarity, ranks them accordingly, and the confidence scores may be used as a measure of the correlation degree. If the correlation degree exceeds a preset threshold (e.g., 90%) or is the highest among the candidates, the corresponding label data is selected as the final output label data. For example, if an object feature is “vehicle,” the correlation degree between this feature and various labels under the “vehicle” label set is calculated. If the correlation degree for the label “sports car” is 85%, and for the label “sedan” is 92%, the processor 120 may determine that the vehicle most likely belongs to the “sedan” category and outputs “sedan” as the label data corresponding to the object feature.

In some embodiments, the processor 120 may assign appropriate labels to the image after analysis by the model, but the present disclosure is not limited thereto. In some embodiments, the processor 120 may extract “potential labels” from the image, where the potential labels may be described as label data (not necessarily all being used). Based on the correlation degree, the processor 120 then outputs the final label data, and the final label data corresponds to the annotation data, but the present disclosure is not limited thereto.

In some embodiments, the processor 120 may use the image-tag recognition decoder to label the image by interacting with the extracted features, but the present disclosure is not limited thereto.

In one embodiment, the processor 120 may generate the plurality of annotation data based on the plurality of object features and the plurality of association degrees by using a decoder, and the plurality of annotation data is related to the image 90.

In the step 513, using an image-label interaction encoder.

In one embodiment, the processor 120 may use the image-label interaction encoder (also referred to as an image-tag-text interaction decoder).

For example, the image-tag-text interaction decoder may interact with the annotation texts (such as cat, lying down, suitcase, pillow, etc.) and the plurality of object features in image 90 to obtain the plurality of association degrees, but the present disclosure is not limited thereto.

In the step 520, performing text parsing.

In one embodiment, the processor 120 may perform text parsing.

For example, the processor 120 may generate a textual description corresponding to image 90, 90A, and/or 90B, such as “A cat laying in a suitcase next to a pillow”, but the present disclosure is not limited thereto.

In the step 521, using image-label-text generation decoder.

In one embodiment, the processor 120 may use the image-label-text generation decoder.

For example, the image-tag recognition decoder may generate captions. In this case, the generated captions may be textual descriptions that best fit or correspond to the context, theme, and/or features of image 90, 90A, and/or 90B, but the present disclosure is not limited thereto.

In the step 522, annotating text.

In one embodiment, the processor 120 may annotate text.

For example, the annotation texts may include terms such as cat, lying down, suitcase, pillow, and so on, but the present disclosure is not limited thereto.

In the step 530, performing text processing. Furthermore, the step 530 includes the step 531 and the step 532.

In one embodiment, the processor 120 may perform the text processing.

In the step 531, obtaining a tag list.

In one embodiment, the processor 120 may obtain a tag list.

For example, the contents of the tag list (also referred to as the label list) may include cat, lying down, suitcase, pillow, dog, person, and so on, but the present disclosure is not limited thereto.

In the step 532, using a text encoder.

In one embodiment, the processor 120 may use the text encoder.

For example, the text encoder may be a CLIP text encoder, but the present disclosure is not limited thereto.

In the step 533, querying text labels.

In one embodiment, the processor 120 may query the text label.

For example, the contents of the text labels may include cat, lying down, suitcase, pillow, dog, person, and so on, but the present disclosure is not limited thereto.

In some embodiments, at least one of the plurality of steps 510 to 530, 511 to 513, 521, 522, and 531 to 533 may be combined. The processor may achieve effective interaction between image features and tags through cross-attention layers in the image-tag interaction encoder and recognition decoder, thereby enhancing overall performance; however, the present disclosure is not limited thereto.

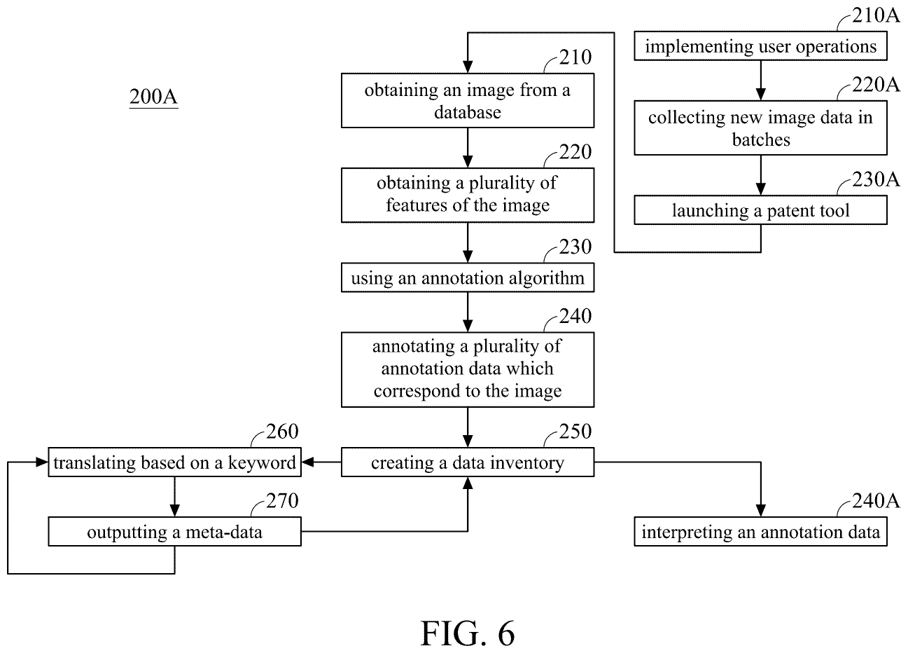

FIG. 6 is a schematic diagram of a plurality of operational steps of an image data processing device according to one embodiment of the present disclosure. As shown in FIG. 6, in one embodiment, the image data processing method 200A may be an extended method based on the image data processing method 200 of FIG. 2. The image data processing method 200A further includes the plurality of steps 210A to 240A.

For a detailed description of the technical content of the plurality of steps 210A to 240A in FIG. 6, please also refer to FIG. 1, FIG. 2, and FIG. 6. The following provides a detailed explanation of the plurality of steps 210A to 240A.

In the step 210A, implementing user operations.

In one embodiment, the processor 120 may implement the user operation.

For example, the processor 120 may select input data sources or adjust relevant parameters according to user requirements, but the present disclosure is not limited thereto.

In the step 220A, collecting new image data in batches.

In one embodiment, the processor 120 may collect the new image data in batches.

For example, the new image data may include the plurality of features, plurality of annotation data, the keyword, and/or the meta-data mentioned in the present disclosure, but the present disclosure is not limited thereto.

In the step 230A, launching a patent tool.

In one embodiment, the processor 120 may launch the patent tool.

For example, the patent tool may be the annotation algorithm 121 and/or the translation function 122, but the present disclosure is not limited thereto.

In the step 240A, interpreting an annotation data. In addition, after step 250 is performed, step 240A may be subsequently executed.

In one embodiment, the processor 120 may interpret the annotation data.

For example, the step 240A may correspond to at least one step in the image data processing method 500 of FIG. 5, but the present disclosure is not limited thereto.

In some embodiments, the meta-data translated (or processed via the translator) in step 250 may subsequently be used for interpreting the annotation data, but the present disclosure is not limited thereto. In some embodiments, the processor 120 may write the meta data into the image file, but the present disclosure is not limited thereto.

In some embodiments, at least one of the plurality of the steps 210A to 240A may be combined. The processor 120 may implement the annotation algorithm 121 and/or translation function 122 as tools, such that after automatic annotation of meta-data on the image data, target scenario data cleaning is performed.

In this embodiment, the technology may be applied to the following scenarios: Scenario 1: Typically, during AI model training (such as the annotation algorithm 121) and the data collection, image data is acquired or collected in batches. The original image data itself does not contain any semantic data data (also referred to as meta-data). By toolizing the patented functionality, the meta-data annotation can be performed each time new data is collected using this tool.

Scenario 2: When processor 120 performs data cleaning, it can generate the meta-data from the collected image data and quickly filter target scenarios through a CSV listing. For example, the processor 120 may select nighttime data for use, but the present disclosure is not limited thereto.

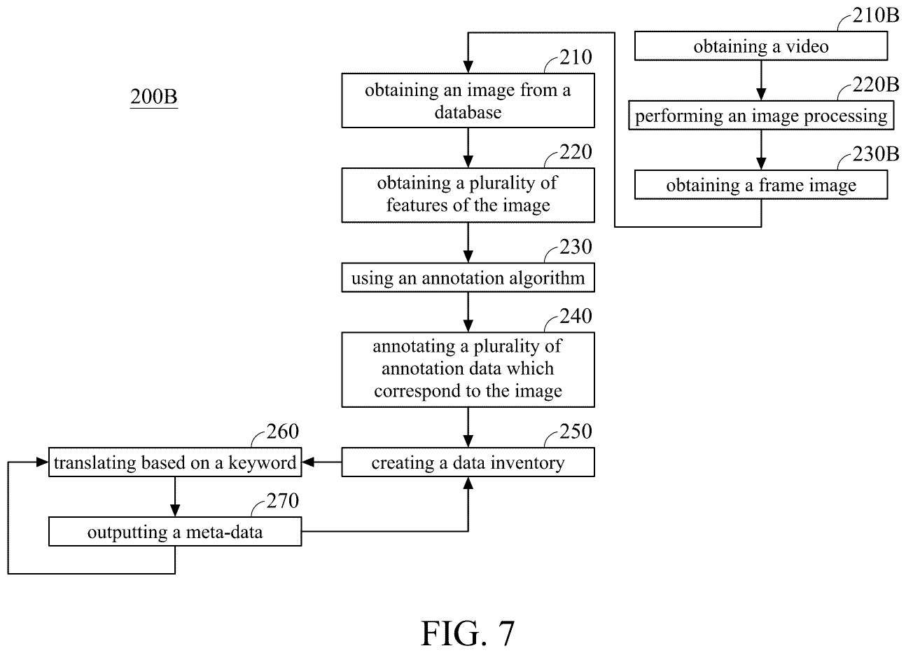

FIG. 7 is a schematic diagram of a plurality of operational steps of an image data processing device according to one embodiment of the present disclosure. As shown in FIG. 7, in one embodiment, the image data processing method 200B may be an extended method based on the image data processing method 200 of FIG. 2. The image data processing method 200B further includes a plurality of steps 210B to 230B.

For a detailed description of the technical content of the plurality of steps 210B to 230B in FIG. 7, please also refer to FIG. 1, FIG. 2, and FIG. 7. The following provides a detailed explanation of the plurality of steps 210B to 230B.

In the step 210B, obtaining a video.

In one embodiment, the processor 120 may obtain the video.

In the step 220B, performing an image processing.

In one embodiment, the processor 120 perform the image processing.

In the step 230B, obtaining a frame image.

In one embodiment, the processor 120 may obtain the frame image.

In some embodiments, at least one of the plurality of steps 210A to 240A may be combined. The processor 120 may convert the video into images. The difference between the images and the videos lies in the need for data preprocessing for videos, since the model performs inference and outputs annotation data on a per-image basis. Therefore, if the collected data is in video format, a preprocessing conversion is required. Generally, the processor 120 may use a computer vision library, such as the Open Source Computer Vision Library (OpenCV), or the conversion algorithms to split the video into individual frames. Then, the processor 120 treats these frames as an input data for the model. In addition, frames may be sampled, for example, inputting one frame every 10 frames into the model to reduce computational complexity, but the present disclosure is not limited thereto.

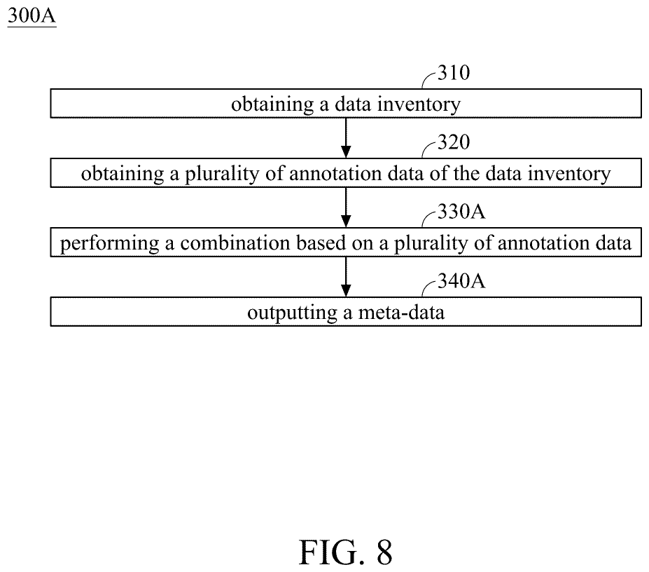

FIG. 8 is a schematic diagram of a plurality of operational steps of an image data processing device according to one embodiment of the present disclosure. As shown in FIG. 8, in one embodiment, the image data processing method 300A may be a method adjusted based on the image data processing method 300 of FIG. 4. It should be specifically noted that the step 320 of the image data processing method 300 may be subsequently executed following step 330A and/or step 340A of the image data processing method 300A.

For a detailed description of the technical content of the plurality of steps 330A to 340A in FIG. 8, please also refer to FIG. 1, FIG. 4, and FIG. 8. The following provides a detailed explanation of the plurality of steps 330A to 340A.

In the step 330A, performing a combination based on a plurality of annotation data.

In one embodiment, the processor 120 may perform the combination based on the plurality of annotation data. In some embodiments, the processor 120 may use a translator to combine a plurality of annotation data in the data inventory into a compound word meta-data, and the meta-data SD1 (as shown in FIG. 1A) includes the compound word meta-data.

For example, the plurality of annotation data may include terms such as nighttime, rainy weather, and intersection. The compound word meta-data can be various logically combined results of the plurality of annotation data. The translator may be the translation function 122 shown in FIG. 1, but the present disclosure is not limited thereto. For example, the compound word meta-data may be a phrase or sentence that accurately describes the image, such as “a nighttime rainy intersection”, but the present disclosure is not limited thereto.

In the step 340A, outputting a meta-data.

In one embodiment, the processor 120 may output meta-data (also referred to as vocabulary meta-data). In some embodiments, the processor 120 may perform an integrated determination by using the translator based on the plurality of annotation data in the data inventory to generate the integrated vocabulary meta-data. The meta-data SD1 (as shown in FIG. 1A) includes the integrated vocabulary meta-data.

For example, the integrated determination may be performed by the processor 120 using one of a large language model (LLM), a convolutional neural network (CNN) model, a machine learning (ML) model, or a mesh model. For instance, the annotation data containing the keyword “illuminated streetlight” combined with annotation data lacking the keyword “night” may undergo integrated determination to generate the integrated vocabulary meta-data “dawn.” Similarly, annotation data containing the keyword “sunset” combined with annotation data containing the keyword “night” may undergo integrated determination to generate the integrated vocabulary meta-data “dusk.”

In some embodiments, the compound vocabulary is composed of multiple words, each of the composed of multiple words is related to a respective piece of annotation data. Furthermore, the multiple words within the integrated vocabulary may be unrelated to each other. In addition, a integrated vocabulary is a single word that relates to multiple pieces of annotation data, but the present disclosure is not limited thereto.

In some embodiments, at least one of the plurality of steps 310 to 340A may be incorporated. Currently, the translator process is designed to apply decision logic based on tag (annotation) information. If the tag information does not include “night,” other tag information, such as “dark” or “sunny,” may be used to assist in the judgment by the processor 120. Alternatively, during the initial planning of training data for the model, tags that may be used in the future can be included as part of the training dataset for subsequent model training, but the present disclosure is not limited thereto.

In some embodiments, practical applications may often involve complex scenes. To identify and construct such scenes, such as a rainy intersection at night, rather than merely a nighttime setting, the processor 120 may determine the scene using translator logic based on a combination of multiple tags, but the present disclosure is not limited thereto.

In some embodiments, the compound word is composed of multiple words, each of multiple words corresponds to a respective tag. In contrast, a composite word consists of a single word that corresponds to multiple tag pieces of information, but the present disclosure is not limited thereto.

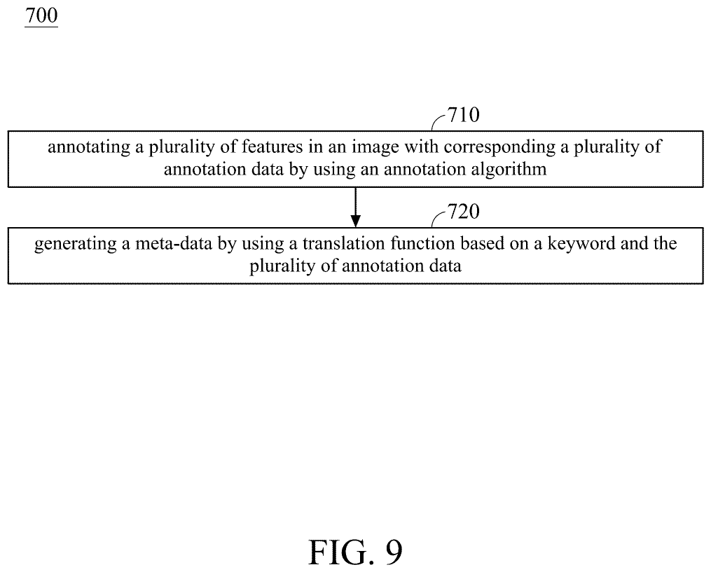

FIG. 9 is a flowchart of an image data processing method according to one embodiment of the present disclosure. As shown in FIG. 9, the image data processing method 700 includes a plurality of steps 710 to 720. To provide a detailed explanation of the plurality of steps 710 to 720 in FIG. 9, please also refer to FIG. 1 through FIG. 9. The following will describe the technical details of the plurality of steps 710 to 720 in detail.

In the step 710, annotating a plurality of features in an image with corresponding a plurality of annotation data by using an annotation algorithm.

In one embodiment, the processor 120 may annotate the plurality of features 901 and 902 in the image 90 with the corresponding plurality of annotation data ST1 and ST2 by using the annotation algorithm 121.

In the step 720, generating a meta-data by using a translation function based on a keyword and the plurality of annotation data.

In one embodiment, the processor 120 may generate the meta-data SD1 based on a keyword SK1 and the plurality of annotation data ST1 and ST2 by using a translation function 122. The meta-data SD1 is related to the keyword SK1.

It should be understood that the above steps do not need to be performed in sequence, and each feature of the embodiments shown in FIG. 1 to FIG. 8 may be applied to the image data processing method 700 of FIG. 9.

In one embodiment, the image data processing method 700 further includes the following steps: creating a data inventory, and the data inventory comprises an image name data corresponding to the image and a plurality of annotation data ST1 and ST2 corresponding to image 90; and outputting a meta-data SD1 corresponding to image 90 based on the plurality of annotation data ST1 and ST2 in the data inventory, and the meta-data SD1 is related to the plurality of annotation data ST1 and ST2 corresponding to image 90.

In one embodiment, the image data processing method 700 further includes the following steps: obtaining a first image 90B, and the image 90 comprises the first image 90B; and outputting a positive example meta-data based on a first annotation data of the first image 90B and a keyword SK1, the first annotation data comprises the keyword SK1, and the meta-data SD1 comprises the positive example meta-data.

In one embodiment, the image data processing method 700 further includes the following steps: obtaining a second image 90A; and outputting a negative example meta-data based on a second annotation data of the second image 90A and a keyword SK1. The second annotation data does not comprise the keyword SK1.

In one embodiment, the image data processing method 700 further includes the following steps: determining whether the plurality of annotation data corresponding to image 90 comprises the keyword SK1; and when it is determined that the plurality of annotation data ST1 and ST2 corresponding to image 90 comprises the keyword SK1, outputting a positive example meta-data. The meta-data SD1 comprises the positive example meta-data.

In one embodiment, the image data processing method 700 further includes the following steps: when it is determined that the plurality of annotation data ST1 and ST2 corresponding to image 90 does not comprise the keyword SK1, outputting a negative example meta-data. The meta-data SD1 comprises the negative example meta-data.

In one embodiment, the image data processing method 700 further includes the following steps: obtaining a plurality of object features of the image by using an image encoder, and the annotation algorithm 121 comprises the image encoder; and determining a plurality of association degrees between the plurality of object features and a plurality of label data based on the plurality of object features and the plurality of label data.

In one embodiment, the image data processing method 700 further includes the following steps: generating the plurality of annotation data based on the plurality of object features and the plurality of association degrees by using a decoder, and the annotation algorithm 121 comprises the decoder.

In one embodiment, the image data processing method 700 further includes the following steps: generating a compound word meta-data based on the plurality of annotation data ST1 and ST2 in the data inventory by using a translation function 122, and the meta-data SD1 comprises the compound word meta-data.

In one embodiment, the image data processing method 700 further includes the following steps: performing an integrated determination based on the plurality of annotation data ST1 and ST2 in the data inventory by using the translation function 122 to generate a compound vocabulary meta-data, and the meta-data SD1 comprises the compound vocabulary meta-data.

In some embodiments, the image data processing method 700 may be implemented by the image data processing device 100, but the present disclosure is not limited thereto. In some embodiments, the image data processing method 700 may be implemented by a non-transitory computer-readable storage medium, but the present disclosure is not limited thereto. In some embodiments, the image data processing method 700 may be implemented by other systems or servers, but the present disclosure is not limited thereto.

In some embodiments, any of the plurality of steps in the image data processing methods 200, 200A, 200B, 300, 300A, 500, and 700 of the present disclosure may be executed in any order, combined for use, and/or correspond to each other in any manner, but the present disclosure is not limited thereto.

Therefore, according to the technical content of the present disclosure, the image data processing device and the image data processing method shown in the embodiment of the present disclosure may utilize an annotation algorithm and a keyword to achieve the effect of improving the efficiency of image data cleaning.

Ordinal numbers in this specification and the claims, such as “first,” “second,” “third,” etc., do not imply any sequential order among themselves. They are only used to denote and distinguish two different elements having the same name.

Although specific embodiments of the present application are disclosed in the foregoing embodiments, they are not intended to limit the present application. A person having ordinary skill in the art to which the present application pertains may make various changes and modifications thereto without departing from the principle and spirit of the present application. Therefore, the protection scope of the present application shall be subject to the scope defined by the accompanying claims.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image data processing device, comprising:
a memory; and
a processor, configured to execute following steps based on a plurality of instructions from the memory:
annotating a plurality of features in an image with a plurality of annotation data by using an annotation algorithm; and
generating a meta-data by using a translation function based on a keyword and the plurality of annotation data;
wherein the meta-data is related to the keyword;
wherein the plurality of annotation data corresponds to the image.

2. The image data processing device as claimed in claim 1, wherein the processor further executes the following steps:
creating a data inventory, wherein the data inventory comprises an image name data corresponding to the image and the plurality of annotation data corresponding to the image; and
outputting the meta-data corresponding to the image based on the plurality of annotation data of the data inventory;
wherein the meta-data is related to the plurality of annotation data corresponding to the image.

3. The image data processing device as claimed in claim 1, wherein the processor further executes the following steps:
obtaining a first image, wherein the image comprises the first image; and
outputting a positive example meta-data based on a first annotation data of the first image and the keyword;
wherein the first annotation data comprises the keyword;
wherein the meta-data comprises the positive example meta-data.

4. The image data processing device as claimed in claim 3, wherein the processor further executes the following steps:
obtaining a second image;
outputting a negative example meta-data based on a second annotation data of the second image and the keyword;
wherein the second annotation data does not comprise the keyword.

5. The image data processing device as claimed in claim 1, wherein the processor further executes the following steps:
determining whether the plurality of annotation data corresponding to the image comprises the keyword; and
when it is determined that the plurality of annotation data corresponding to the image comprises the keyword, outputting a positive example meta-data;
wherein the meta-data comprises the positive example meta-data.

6. The image data processing device as claimed in claim 5, wherein the processor further executes the following steps:
when it is determined that the plurality of annotation data corresponding to the image does not comprise the keyword, outputting a negative example meta-data;
wherein the meta-data comprises the negative example meta-data.

7. The image data processing device as claimed in claim 2, wherein the processor further executes the following steps:
obtaining a plurality of object features of the image by using an image encoder, wherein the annotation algorithm comprises the image encoder; and
determining a plurality of association degrees between the plurality of object features and a plurality of label data based on the plurality of object features and the plurality of label data.

8. The image data processing device as claimed in claim 7, wherein the processor further executes the following steps:
generating the plurality of annotation data based on the plurality of object features and the plurality of association degrees by using a decoder;
wherein the annotation algorithm comprises the decoder.

9. The image data processing device as claimed in claim 1, wherein the processor further executes the following steps:
generating a compound word meta-data based on the plurality of annotation data of the data inventory by using a translation function;
wherein the meta-data comprises the compound word meta-data.

10. The image data processing device as claimed in claim 1, wherein the processor further executes the following steps:
performing an integrated determination based on the plurality of annotation data by using the translation function to generate an integrated vocabulary meta-data;
wherein the meta-data comprises the integrated vocabulary meta-data.

11. An image data processing method, comprising:
annotating a plurality of features in an image with a plurality of annotation data by using an annotation algorithm; and
generating a meta-data by using a translation function based on a keyword and the plurality of annotation data;
wherein the meta-data is related to the keyword;
wherein the plurality of annotation data corresponds to the image.

12. The image data processing method as claimed in claim 11, further comprising:
creating a data inventory, wherein the data inventory comprises an image name data corresponding to the image and the plurality of annotation data corresponding to the image; and
outputting the meta-data corresponding to the image based on the plurality of annotation data of the data inventory;
wherein the meta-data is related to the plurality of annotation data corresponding to the image.

13. The image data processing method as claimed in claim 11, further comprising:
obtaining a first image, wherein the image comprises the first image; and
outputting a positive example meta-data based on a first annotation data of the first image and the keyword;
wherein the first annotation data comprises the keyword;
wherein the meta-data comprises the positive example meta-data.

14. The image data processing method as claimed in claim 13, further comprising:
obtaining a second image;
outputting a negative example meta-data based on a second annotation data of the second image and the keyword;
wherein the second annotation data does not comprise the keyword.

15. The image data processing method as claimed in claim 11, further comprising:
determining whether the plurality of annotation data corresponding to the image comprises the keyword; and
when it is determined that the plurality of annotation data corresponding to the image comprises the keyword, outputting a positive example meta-data;
wherein the meta-data comprises the positive example meta-data.

16. The image data processing method as claimed in claim 15, further comprising:
when it is determined that the plurality of annotation data corresponding to the image does not comprise the keyword, outputting a negative example meta-data;
wherein the meta-data comprises the negative example meta-data.

17. The image data processing method as claimed in claim 12, further comprising:
obtaining a plurality of object features of the image by using an image encoder, wherein the annotation algorithm comprises the image encoder; and
determining a plurality of association degrees between the plurality of object features and a plurality of label data based on the plurality of object features and the plurality of label data.

18. The image data processing method as claimed in claim 17, further comprising:
generating the plurality of annotation data based on the plurality of object features and the plurality of association degrees by using a decoder;
wherein the annotation algorithm comprises the decoder.

19. The image data processing method as claimed in claim 12, further comprising:
generating a compound word meta-data based on the plurality of annotation data of the data inventory by using a translation function;
wherein the meta-data comprises the compound word meta-data.

20. The image data processing method as claimed in claim 11, further comprising:
performing an integrated determination based on the plurality of annotation data by using the translation function to generate an integrated vocabulary meta-data;
wherein the meta-data comprises the integrated vocabulary meta-data.
